(19) United States
(12) Patent Application Publication
(10) Pub. No.: US 2015/0131349 A1
(43) Pub. Date: May 14, 2015

(54) SYSTEM AND METHOD FOR BALANCING MULTILEVEL POWER CONVERTERS

(71) Applicant: General Electric Company, Schenectady, NY (US)

(72) Inventors: Said Farouk Said El-Barbari, Bavaria (DE); Silvio Colombi, Losone (CH); Rajendra Naik, Bangalore (IN); Luke Anthony Solomon, Pittsburgh, PA (US); Siddharth Pant, Pittsburgh, PA (US); Alfred Permuy, Hauts-de-Seine (FR)

(73) Assignee: General Electric Company, Schenectady, NY (US)

(21) Appl. No.: 14/077,309

(22) Filed: Nov. 12, 2013

(51) Int. Cl. H02M 7/537

(52) U.S. Cl. CPC H02M 7/537
USPC 363/131

(57) ABSTRACT

A system including a multi-level power converter is provided. The system also includes a plurality of DC link capacitors and a balancing circuit coupled to the multi-level power converter. The balancing circuit further includes two sets of interface branches. Each set includes a plurality of interface branches and a plurality of switching elements. The balancing circuit also includes a battery coupled to one or more inductors across the two sets of interface branches and a controller for controlling switching operations of the plurality of switching elements for modifying a voltage of the battery to balance voltages of the plurality of DC link capacitors.

### BACKGROUND

Embodiments of the invention generally relate to power converters and more particularly relate to a system and method for balancing DC voltage of multilevel power converters.

A multilevel power converter is a power electronic assembly that is used to produce various levels of AC voltage waveforms from one or more DC voltage sources. One type of multilevel power converter includes a number of semiconductor switches coupled to a number of lower level DC voltage sources to perform power conversion by synthesizing a staircase voltage waveform.

In a more specific power conversion system, a bank of capacitors is coupled to one or more of the DC voltage sources. Under normal sinusoidal operation, a DC link including the bank of capacitors in a three or more level multilevel power converter tends to become unbalanced. The unbalanced voltages in the bank of capacitors adversely affect the performance of the multilevel power converter by generating uncharacterized harmonics in the output voltage of the multilevel power converter and inducing overvoltage conditions in the semiconductor switches.

A multi-secondary winding transformer with a rectifier circuit has been proposed as one approach to inherently enforce a voltage balance across all capacitors. In another approach, advanced control techniques have been used to control a load current to manage energy flow from the bank of capacitors. However, such techniques are expensive and may be functionally inadequate for various applications of the multilevel inverter.

In commonly assigned Permuy et al., US2012/0161858, a balancing interface is coupled to the multilevel power converter. The balancing interface is coupled to multiple capacitors and a controller. The controller controls charging and discharging of an inductor in the balancing interface to balance voltage in the multiple capacitors coupled to the balancing interface. There are some applications, however, where the balancing interface of Permuy is less suitable.

Hence, there is a need for an improved system to address the aforementioned issues.

### BRIEF DESCRIPTION

Briefly, in accordance with one embodiment, a system including a multi-level power converter is provided. The system also includes a plurality of DC link capacitors and a balancing circuit coupled to the multi-level power converter. The balancing circuit further includes two sets of interface branches. Each set includes a plurality of interface branches, and each interface branch includes a plurality of switching elements. The balancing circuit also includes a battery coupled to one or more inductors across the two sets of interface branches and a controller for controlling switching operations of the plurality of switching elements for modifying a voltage of the battery to balance voltages of the plurality of DC link capacitors.

In another embodiment, a method for balancing voltages in a multilevel power converter is provided. The method includes determining voltages of a plurality of DC link capacitors coupled to the multilevel power converter, computing a balanced voltage condition for the plurality of DC link capacitors, switching at least one switching element to charge a battery using voltage from at least one of the DC link capacitors having a respective individual voltage above the computed balanced voltage condition; and switching the at least one switching element to discharge the battery and increase the voltage of at least one of the DC link capacitors having a respective individual voltage below the computed balanced voltage condition.

In yet another embodiment, a power transfer system is provided. The system also includes a plurality of DC link capacitors and a balancing circuit coupled to a multi-level power converter. The balancing circuit further includes two sets of interface branches. Each set includes a plurality of interface branches, and each interface branch includes a plurality of switching elements. The balancing circuit also includes a battery coupled to one or more inductors across the two sets of interface branches and a controller for controlling switching operations of the plurality of switching elements for transferring power from the battery to the multi-level power converter for operating a load coupled to the multi-level power converter.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a system including a multilevel power converter and a balancing circuit in accordance with an embodiment of the invention.

FIG. 2 is a schematic representation of a balancing circuit depicting charging of a battery using a first capacitor in accordance with an embodiment of the invention.

FIG. 3 is a schematic representation of a balancing circuit depicting circulating current in the balancing circuit in accordance with an embodiment of the invention.

FIG. 4 is a schematic representation of a balancing circuit depicting discharging of a battery and charging of an inductor in accordance with an embodiment of the invention.

FIG. 5 is a schematic representation of a balancing circuit depicting discharging of the inductor and charging of a second inductor in accordance with an embodiment of the invention.

FIG. 6. is a flow chart representing steps involved in a method for balancing voltages in a multilevel power converter in accordance with an embodiment of the invention.

### DETAILED DESCRIPTION

Embodiments of the present invention include a system and method for balancing voltages in a multilevel power converter. The system includes a plurality of DC link capacitors and a balancing circuit coupled to the multi-level power converter. The balancing circuit further includes two sets of interface branches. Each set includes a plurality of interface branches and each interface branch includes a plurality of switching elements. The balancing circuit also includes a battery coupled to one or more inductors across the two sets of interface branches and a controller for controlling switching operations of the plurality of switching elements for modifying a voltage of the battery to balance voltages of the plurality of DC link capacitors.

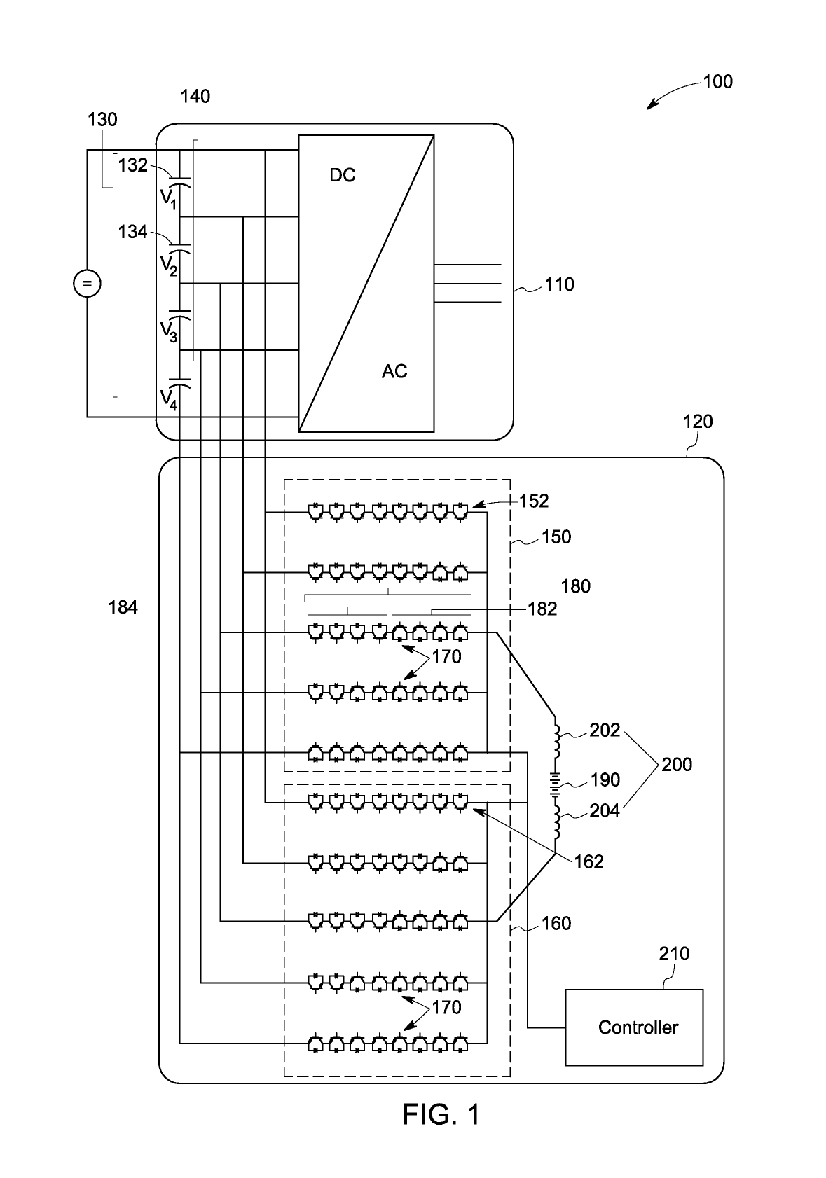

FIG. 1 is a schematic representation of a system 100 including a multilevel power converter 110 and a balancing circuit 120 in accordance with an embodiment of the invention. The multilevel power converter 110 is used to convert an input power to an output power. The system 100 further includes a plurality of DC link capacitors 130 coupled to the multi-level power converter 110. In one embodiment, the multi-level power converter 110 may include a multilevel inverter and converts DC power received from the DC link capacitors 130 to AC power. In a specific embodiment, the plurality of DC link capacitors may include a root mean square voltage rating of above one kilo volts. The DC link capacitors 130 are coupled in series to each other, and positive terminals and negative terminals of each of the DC link capacitors 130 are coupled to the multi-level converter 110 to form a DC link 140.

The system 100 further includes the balancing circuit 120 coupled to the DC link 140. The balancing circuit 120 includes two sets of interface branches 150, 160 in which each set 150, 160 includes a plurality of interface branches 170. In one embodiment, each set of the interface branches 150, 160 includes the same number of interface branches 170. Each of the plurality of interface branches 170 includes a plurality of switching elements 180 that are used to control a flow of current in the system 100. In the embodiment of FIG. 1, the switching elements 180 are shown as coupled in series in each interface branch 170 of the two sets 150, 160. The switching elements 180 may comprise, for example, insulated gate bipolar transistors (IGBTs). In one embodiment, a number of switching elements 180 in a first branch 152 of a first set 150 is equal to a number of switching elements 180 in a first branch 162 of a second set 160. The switching elements 180 in each of the interface branches 170 may be coupled in a forward biased direction or a reverse biased direction. In one specific example, a number of forward biased switching elements 182 and reverse biased switching elements 184 in each of the interface branches 170 of the first set 150 is same with respect to the corresponding interface branch 162 in the second set 160. Similarly, the positioning of the forward biased switching elements 182 and the reversed biased switching elements 184 in each of the interface branches 152 of the first set 150 may be identical to a positioning of the forward biased switching elements 182 and the reverse biased switching elements 184 in the corresponding first interface branch 162 in the second set 160. In one embodiment, the corresponding interface branches in the first set 150 and the second set 160 are coupled in parallel to each other.

In one embodiment, the two sets of interface branches 150, 160 are coupled to a battery 190 which is coupled to at least one inductor 200 across the two sets of interface branches 150, 160. In the specific embodiment of FIG. 1, each set 150, 160 is coupled to a respective one of inductors 202, 204 to provide symmetrical potential to ground for minimizing common mode current. In one embodiment, the two inductors 200 may comprise boost inductors. In another embodiment, a number of inductors 200 coupled to each set 150, 160 are equal. Aforementioned Permuy et al., US2012/0161858 describes balancing of voltages of a plurality of DC link capacitors with a unidirectional current flow. In contrast, embodiments disclosed herein enable a bi-directional current flow in the balancing circuit 120 that further enables coupling of a battery 190 including a root mean square voltage rating below one kilo volts to a plurality of DC link capacitors 130 including a root mean square voltage rating above one kilo volts. In one embodiment, the system 100 acts as an uninterrupted power supply system and uses the battery 190 as an energy storage device. In such embodiments, the battery 190 balances voltages of the plurality of DC link capacitors 130 during power being transferred from the plurality of DC link capacitors 130 to the multi-level power converter 110. Furthermore, battery 190 may provide battery power to the multi-level power converter 110 if the plurality of DC link capacitors 130 are unable to transfer the power to the multi-level power converter 110. The battery 190 is coupled between the at least one inductor 200 of each set 150, 160. In a specific embodiment, the battery 190 may have a battery voltage rating lower than a capacitor voltage rating, and the battery 190 is used to store excess energy received from the plurality of DC link capacitors 130 and provide additional energy to the plurality of DC link capacitors 130 when required to maintain a balance in voltages across the plurality of DC link capacitors 130.

The system 100 further includes a controller 210 coupled to the two sets of interface branches 150, 160. The controller 210 controls the switching operations of the plurality of switching elements 180 for modifying a voltage of the battery 190 to balance voltages of the plurality of DC link capacitors 130. The controller 210 obtains information regarding the voltages of the plurality of DC link capacitors 130 coupled to the multilevel power converter 110 and computes a balanced voltage condition for the plurality of DC link capacitors 130. In one embodiment, the balanced voltage condition is computed by computing an average voltage between the plurality of DC link capacitors 130. Subsequently, the controller 210 identifies high potential DC link capacitors 132 having a respective individual voltage above the computed balanced voltage condition. The controller 210 switches at least one of the switching elements 180 in the respective interface branches 170 coupled to the high potential DC link capacitors 132 such that current from the high potential DC link capacitors 132 flows towards the battery 190.

The controller 210 may identify one or more high potential DC link capacitors 132 with respective individual voltages above the computed balanced voltage condition. In one embodiment, the controller 210 switches the switching elements 180 in the respective interface branches 170 such that at any instant of time the current flows only from one high potential DC link capacitor 132 to the battery 190. In a more specific embodiment, the controller 210 discharges the one or more high potential DC link capacitors 132 in a descending manner starting with the high potential DC link capacitor having highest voltage above the computed balanced voltage condition.

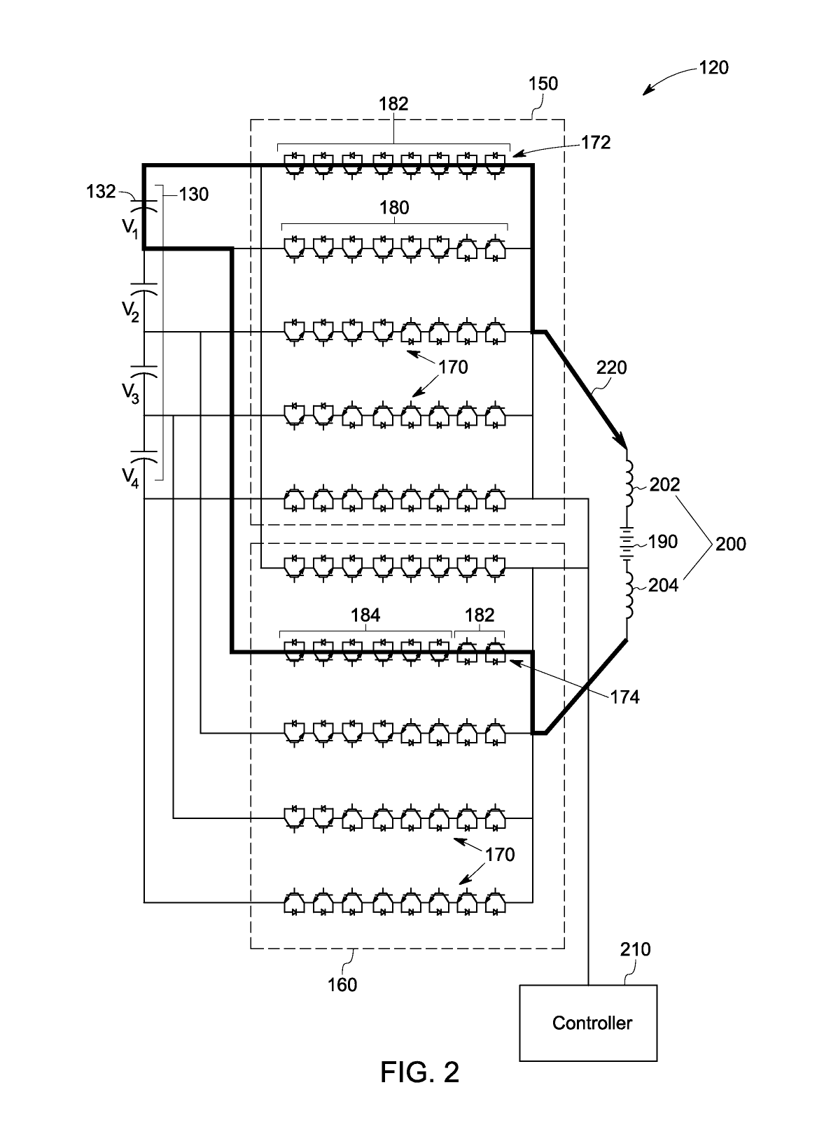

The controller 210 further discharges the battery 190 and provides a path for the current to flow to at least one of low potential DC link capacitors 134 which have a respective individual voltage below the computed balanced voltage condition. The controller 210 switches the at least one switching element 180 of the respective interface branches 170 coupled to the at least one low potential DC link capacitors 134 to provide the path for the current to flow from the battery 190 to the at least one low potential DC link capacitor 134. Similarly, controller 210 may discharge and charge the plurality of DC link capacitors 130 according to their respective individual voltages with respect to the balanced voltage condition. The method of charging and discharging of the plurality of DC link capacitors 130 is described in greater detail with respect to FIG. 2-5.

FIG. 2 is a schematic representation of a balancing circuit 120 depicting charging of the battery 190 using a first DC link capacitor 132 in accordance with an embodiment of the invention. The controller 210 computes the balanced voltage condition and identifies high potential DC link capacitors 132 that have the voltage above the balanced voltage condition. For example, assuming that the controller 210 identifies a first DC link capacitor as the high potential DC link capacitor 132, the controller 210 further compares the voltage of the first DC link capacitor 132 with a voltage of the battery 190. If the voltage of the battery 190 is lower than the voltage of the first DC link capacitor 132, the controller 210 switches the plurality of switching elements 180 in the interface branches 170 coupled to the two terminals of the first DC link capacitor 132 in the two sets of the interface branches 150, 160. The interface branch 170 in the first set 150 and coupled to a positive terminal of the first DC link capacitor 132 is termed as a positive terminal interface branch 172, and the interface branch 170 in the second set 160 and coupled to a negative terminal of the first DC link capacitor 132 is termed as a negative terminal interface branch 174.

The positive terminal interface branch 172 includes a plurality of forward biased switching elements 182 and the negative terminal interface branch 174 includes a plurality of reverse biased switching elements 184 and a plurality of forward biased switching elements 182. The controller 210 switches the plurality of forward biased switching elements 182 in the positive terminal interface branch 172 to an “ON” state. Simultaneously, the controller 210 also switches the plurality of forward biased switching elements 182 and the plurality of reverse biased switching elements 184 in the negative terminal interface branch 174 to the “ON” state. Hereinafter, an “ON” state may be defined as a conducting state of the switching elements 180, where both forward biased switching elements 182 and the reverse biased switching elements 184 are turned on and the current can flow in both directions, and an “OFF” state may be defined as a state in which both forward biased switching elements 182 and the reverse biased switching elements 184 are turned off such that the current will not flow in either direction. Moreover, if only the forward biased switching elements 182 are turned on and the reverse biased switching elements 184 are turned off, the switching elements 180 will allow the current to flow in the forward biased direction only and will block any reverse current, Alternatively, if only the reverse biased switching elements 184 are turned on and the forward biased switching elements 182 are turned off, the switching elements 180 will allow the current to flow in the reverse direction only and will block any forward current. Since the voltage of the first DC link capacitor 132 is higher than the voltage of the battery 190, the current flows from the first DC link capacitor 132 to the battery 190 via a path 220.

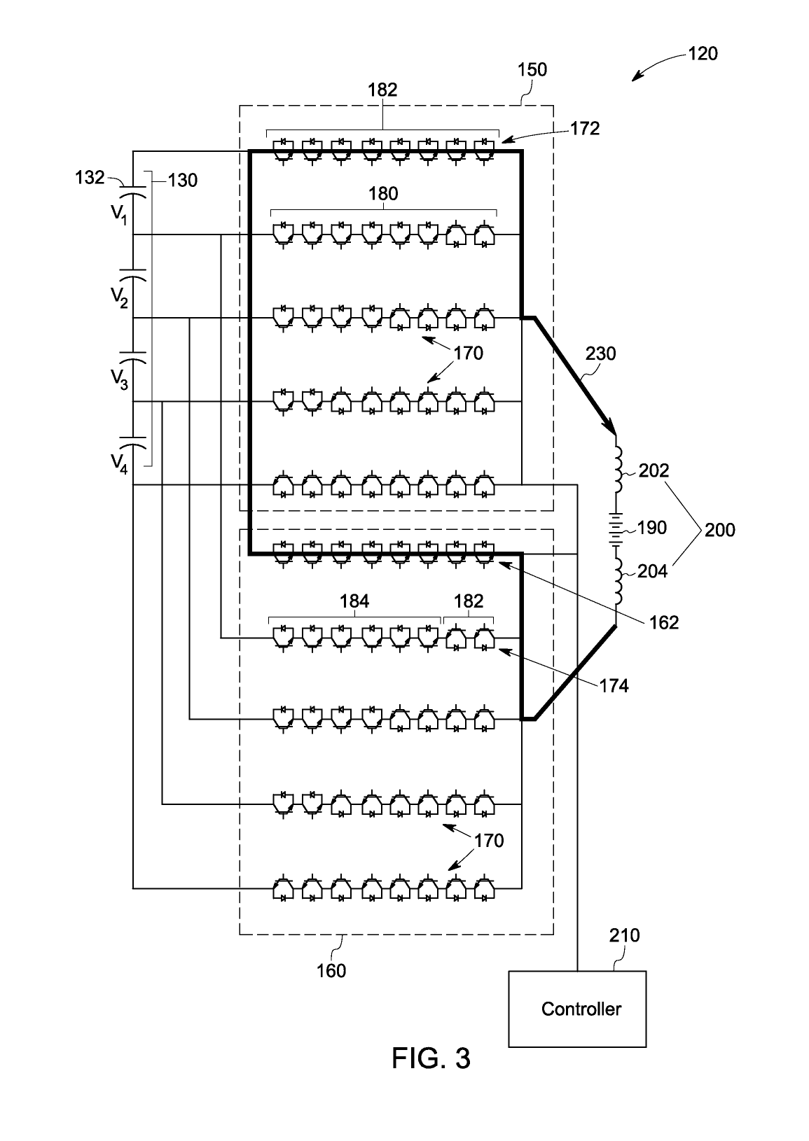

FIG. 3 is a schematic representation of the balancing circuit 120 depicting circulating current in the balancing circuit 120 in accordance with an embodiment of the invention. The battery 190 is coupled between the two inductors 200, and the current from the first DC link capacitor 132 flows through a first inductor 202 to the battery 190. The current flowing to the battery 190 charges the first inductor 202. The controller 210 monitors a charging status of the first inductor 202, and after the first inductor 202 reaches an upper threshold limit of the charging status, the controller 210 switches the forward biased switching elements 182 in the negative terminal interface branch 174 to an “OFF” state to avoid damage to the first inductor 202. The controller 210 by switching the forward biased switching elements 182 of the negative terminal interface branch 174 allows the current in the first inductor 202 to flow through the first interface branch 162 above the negative terminal interface branch 174. The current in the first inductor 202 circulates through diodes of the first interface branch 162 and the switching elements 182 of the positive terminal interface branch 172 until the current in the first inductor 202 reaches a lower threshold limit. In the aforementioned example with respect to discharging of the first DC link capacitor 132, the circulation of current through the first inductor 202 is shown by circulation path 230. The controller 210 repeats the above mentioned switching process until the voltage in the first DC link capacitor 132 reaches the balanced voltage condition or until the battery is charged.

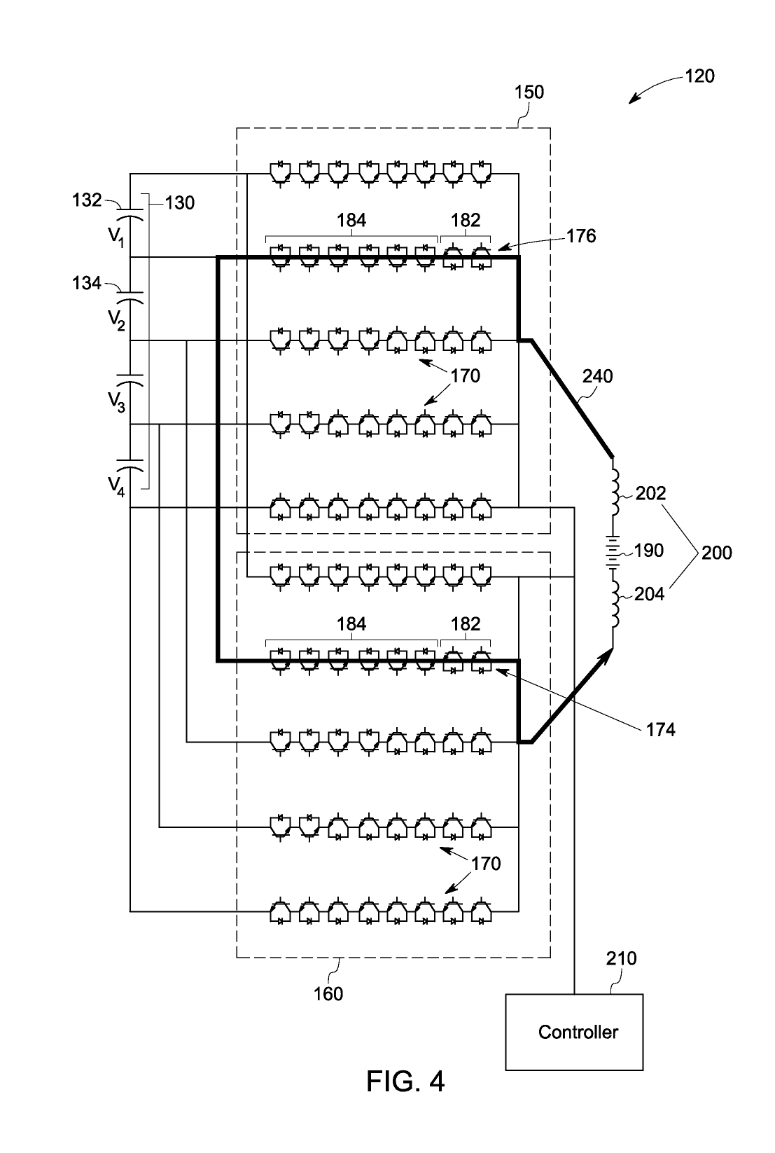

FIG. 4 is a schematic representation of the balancing circuit 120 depicting discharging of the battery 190 and charging of the DC link capacitor 134 accordance with an embodiment of the invention. In continuation to the example discussed in FIG. 2 of discharging the first DC link capacitor 132 to the balanced voltage condition, assume that the low potential DC link capacitor 134 is a second DC link capacitor 134 that includes a voltage below the balanced voltage condition. As discussed above the controller 210 discharges the first DC link capacitor 132 and charges the battery 190. The controller 210 further determines that the second DC link capacitor 134 includes a voltage less than the balanced voltage condition and uses the battery 190 to charge the second DC link capacitor 134. The controller 210 shorts the battery 190 by switching the forward biased switching elements 182 and the reversed biased switching elements 184 in a second positive terminal interface branch 176 of the second DC link capacitor 134 to the “ON” state. The current flows from the battery 190 to charge the inductors 200. The controller 210 monitors the charging status of the inductors 200 and determines if the inductors 200 have reached the upper threshold of charging status. The flow of current from the battery 190 to the inductors 200 is depicted by path 240.

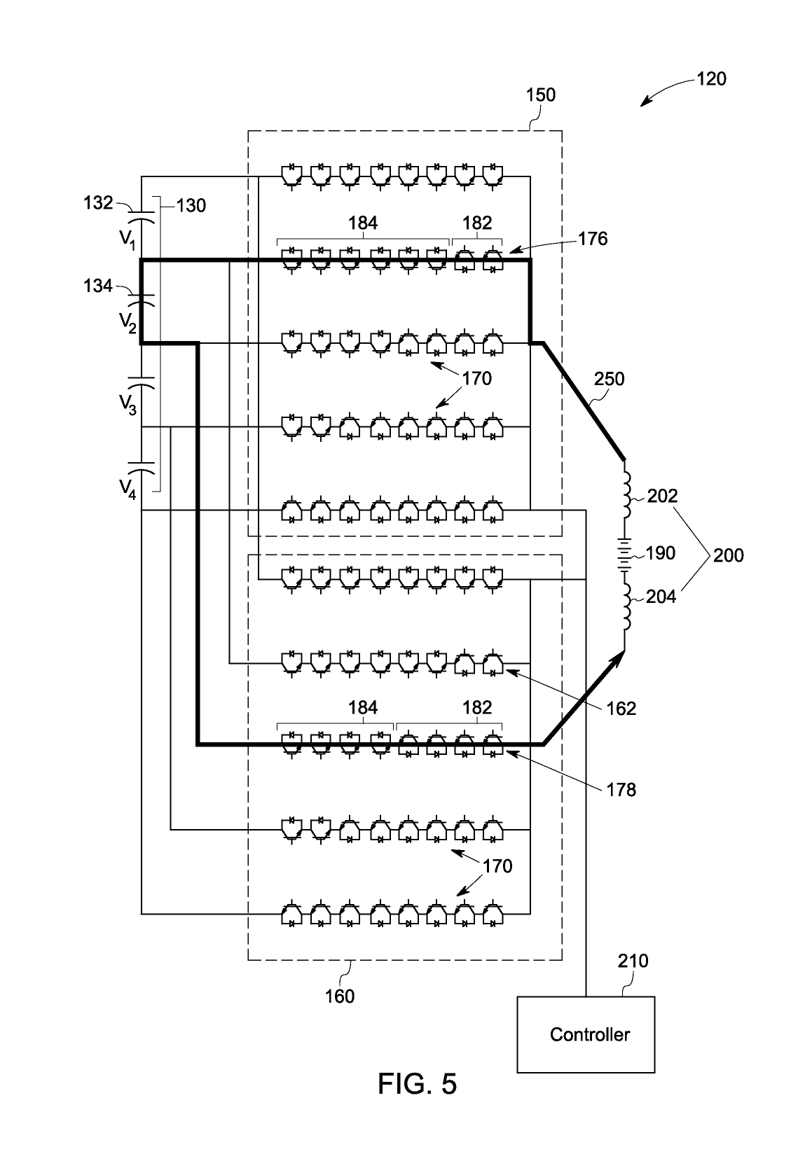

FIG. 5 is a schematic representation of the balancing circuit 120 depicting discharging of the inductors 200 and charging of the second DC link capacitor 134 in accordance with an embodiment of the invention. Upon reaching an upper threshold of charging status of the inductors 200, the controller 210 switches the switching elements 180 in a second negative terminal interface branch 178 to an “ON” state. The current from the inductors 200 flows to the second DC link capacitor 134 via path 250 and charges the second DC link capacitor 134. The controller 210 repeats the aforementioned process until the second DC link capacitor 134 reaches the balanced voltage condition or the battery reaches a terminal charge status. Similarly, the controller 210 may switch the switching elements 180 of any interface branch 170 in the two sets 150, 160 to charge or discharge any of the plurality of DC link capacitors 130 coupled to the multi-level power converter 110.

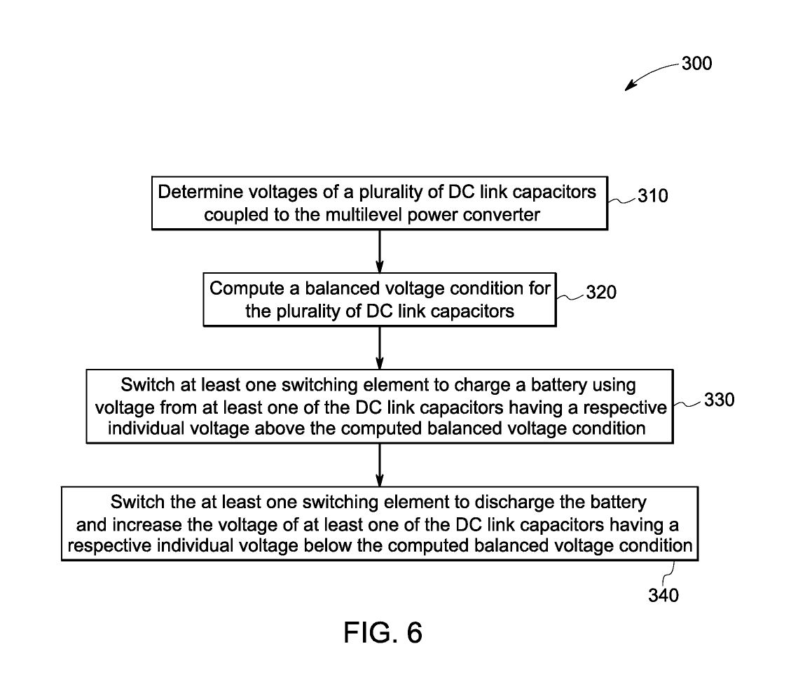

FIG. 6. is a flow chart representing steps involved in a method for balancing voltages in a multilevel power converter in accordance with an embodiment of the invention. The method includes determining voltages of a plurality of DC link capacitors coupled to the multilevel power converter in step 310. Subsequently, a balanced voltage condition is computed for the plurality of DC link capacitors in step 320. In one embodiment, an average voltage of the plurality of DC link capacitors is computed to compute the balanced voltage condition. In step 330, at least one switching element is switched to charge a battery using voltage from at least one of the capacitors having a respective individual voltage above the computed balanced voltage condition. In one embodiment, at least one inductor is charged using the voltage of at least one of the capacitors, and energy is transmitted from the at least one inductor to the battery. In a more specific embodiment, the at least one switching element includes an insulated gate bipolar transistor switch. Furthermore, the at least one switching element is switched to discharge the battery and increase the voltage of at least one of the DC link capacitors having a respective individual voltage below the computed balanced voltage condition in step 340. In a specific embodiment, the at least one switching element is switched to provide a path for current to flow between the plurality of DC link capacitors and the battery. In one embodiment, at least one inductor is charged by discharging the battery and energy is transmitted from the at least one inductor to the at least one of the DC link capacitors.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a multi-level power converter;
a plurality of DC link capacitors coupled to the multi-level power converter
a balancing circuit comprising:
two sets of interface branches, each set of interface branches comprising a plurality of interface branches comprising a plurality of switching elements;
a battery coupled to one or more inductors across the two sets of interface branches; and
a controller for controlling switching operations of the plurality of switching elements for modifying a voltage of the battery to balance voltages of the plurality of DC link capacitors.

2. The system of claim 1, wherein the plurality of DC link capacitors comprise a root mean square voltage rating of above one kilo volts.

3. The system of claim 1, wherein the battery has a root mean square voltage rating of below one kilo volts.

4. The system of claim 1, wherein the one or more inductors are coupled symmetrically to the two sets of interface branches and are configured to minimize common mode current.

5. The system of claim 1, wherein the plurality of switching elements comprise a plurality of forward biased switching elements, a plurality of reverse biased switching elements or a combination thereof to permit a bi-directional flow of energy in the balancing circuit.

6. The system of claim 1, wherein the plurality of switching elements are coupled in series to each other in each interface branch.

7. The system of claim 1, wherein the two sets of interface branches comprise corresponding identical interface branches.

8. The system of claim 1, wherein the two sets of interface branches are coupled in parallel to each other.

9. The multi-level power converter of claim 1, wherein the plurality of switching elements comprise insulated gate bipolar transistors (IGBTs).

10. A method for balancing voltages in a multilevel power converter comprising:
using voltages of a plurality of DC link capacitors coupled to the multilevel power converter for computing a balanced voltage condition for the plurality of DC link capacitors;
switching at least one switching element to charge a battery using voltage from at least one of the DC link capacitors having a respective individual voltage above the computed balanced voltage condition; and
switching the at least one switching element to discharge the battery and increase the voltage of at least one of the DC link capacitors having a respective individual voltage below the computed balanced voltage condition.

11. The method of claim 10, wherein computing the balanced voltage condition comprises computing an average voltage of the plurality of DC link capacitors.

12. The method of claim 10, wherein charging the battery comprises charging at least one inductor using the voltage of at least one of the DC link capacitors and transmitting energy from the at least one inductor to the battery.

13. The method of claim 10, wherein switching the at least one switching element to discharge the battery comprises charging at least one inductor by discharging the battery and transmitting energy from the at least one inductor to the at least one of the DC link capacitors.

14. The method of claim 10, wherein the battery comprises a root mean square voltage rating of below one kilo volts or a battery voltage rating lower than a capacitor voltage rating.

15. The method of claim 10, wherein the at least one switching element comprises at least one insulated gate bipolar transistor.

16. The method of claim 10, wherein switching the at least one switching element comprises providing a path for current to flow between the plurality of DC link capacitors and the battery.

17. A power transfer system comprising:
a multi-level power converter;
a plurality of DC link capacitors coupled to the multi-level power converter a balancing circuit comprising:
two sets of interface branches, each set of interface branches comprising a plurality of interface branches comprising a plurality of switching elements;
a battery coupled to one or more inductors across the two sets of interface branches; and
a controller for controlling switching operations of the plurality of switching elements for transferring power from the battery to the multi-level power converter for operating a load coupled to the multi-level power converter.

18. The power converter system of claim 17, wherein the power transfer system comprises an uninterrupted power supply system.

19. The power converter of claim 17, wherein the multi-level power converter receives power from the plurality of DC link capacitors or the battery.

20. The power converter of claim 19, wherein the battery is configured to balance voltages of the plurality of DC link capacitors during power being transferred from the plurality of DC link capacitors to the multi-level power converter and during transferring of battery power to the multi-level power converter when the plurality of DC link capacitors are unable to transfer the power to the multi-level power converter.
